(19) United States
(12) Patent Application Publication
(10) Pub. No.: US 2003/0210346 A1
(43) Pub. Date: Nov. 13, 2003

(54) Surveillance camera housing

(76) Inventor: James J. Hildreth, Ickleford (GB)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/279,587

(22) Filed: Oct. 24, 2002

Related U.S. Application Data
(60) Provisional application No. 60/378,591, filed on May 8, 2002.

(51) Int. Cl. H04N 5/225

(52) U.S. Cl. 348/373

(57) ABSTRACT

Housings for surveillance devices are disclosed. In an embodiment, a housing is formed by securing a body to a hood at a sloped frame member to provide adequate sealing to protect the camera against the environment and damage. In another embodiment, the body of the housing is suitably adapted for particular applications including corner mounting. In accordance with a particular feature of the present invention, the hood includes a cylindrical aperture which provides a wide viewing angle for the device.

### CROSS-REFERENCE TO RELATED APPLICATIONS

The priority date for this Utility Patent Application is established by Provisional Patent Application No. 60/378,591, for which the filing date was May 8, 2002 and the application was entitled “Surveillance Camera Housing,” the entire disclosure of which is hereby incorporated by reference.

### BACKGROUND OF THE INVENTION

The present invention relates to surveillance devices, and more particularly to such devices having housings that allow for wide angle fields of view and flexible mounting of such devices in various locations.

With the advent of miniature video cameras, such as CCD (charged coupled device) cameras, surveillance products or devices incorporating such miniature cameras have dramatically proliferated, spawning unprecedented growth in the surveillance industry. Although some surveillance cameras raise immediate concerns regarding privacy, many industries today must use hidden cameras as an additional security measure in order to protect their inventory, premises and customers. For instance, financial institutions often use surveillance cameras to offer additional protection to their customers and to help guard against theft. Surveillance cameras are also being used more frequently in the home for the protection of children and personal property.

Within the surveillance industry, there are two types of surveillance activities. In the first instance, surveillance cameras are often mounted in enclosures that allow such devices to be hidden or discrete. In contrast, such cameras are also often mounted in devices which are overt and can be seen rather easily. Whether employed in an overt or discrete application, surveillance devices provide benefit either by recording activity or deterring certain activity.

Surveillance devices are required to be mounted in many different locations and under many different environmental conditions. In particular, the devices are required to be flexible enough to be mounted in a corner, ceiling, or along a corridor, while also providing a requisite viewing angle. For example, surveillance of a corridor requires an approximate viewing angle of 180°, extending in opposite directions down the corridor. For a ceiling mounted application, a larger field of view is typically required. In addition to the various mounting locations and the wide angle of view required, the housing of such surveillance devices must be built to keep dust, moisture, and other possible contaminants from entering the interior where the cameras are mounted. Such contaminants typically affect the reliability of the camera thereby adding to the expense of performing surveillance.

The foregoing factors place constraints on the housing designs for surveillance devices. Specifically, while surveillance devices must be manufactured at a cost that the market will bear, such devices must also be flexible, provide wide angles of view, and provide an adequate environment for housing the cameras themselves.

With respect to providing a wide-angle field of view, prior art housings typically provide a limited field of view because the radial center of the view aperture and the focal point of the camera cannot be arranged so as to coincide with each other within the surveillance housing. Such limitations are imposed by both the curvature of the viewing aperture and the size of the curvature's opening, which partly depends on the size of the housing. These limitations prevent prior art housings and the camera housed therein from providing the wide-angle field of views required for many surveillance application.

The prior art is deficient in satisfying the needs of the surveillance industry based on the aforementioned factors and constraints. Of utility then is an apparatus for housing a surveillance camera that can be mounted in a variety of locations, thereby supporting a variety of applications, that provides a substantially airtight environment for the cameras, and that is priced to meet the demands of the marketplace.

### SUMMARY OF THE INVENTION

In view of the shortcomings of the prior art, one aspect of the present invention is a housing for a surveillance camera which includes a back wall, at least one side wall extending transversely from the back wall to form a partial enclosure operable to house at least one surveillance camera, and a cylindrical front wall having a substantially cylindrical aperture, said cylindrical front wall being coupled to said partial enclosure to form the housing such that the substantially cylindrical aperture is operable to permit a field of view for allowing camera surveillance. In accordance with this aspect of the present invention, the cylindrical aperture or opening allows for a wide viewing angle and allows the camera to be mounted in almost any location. For example, simply by having this cylindrical opening the camera may be placed in the middle of a corridor with cameras pointing in opposite directions. In a particular embodiment of the present invention, the aperture is provided by using an opaque, flexible, but hard glass which protects the camera from damage.

In another aspect of the present invention, a housing kit comprising at least one first portion, each first portion including a back wall and at least one side wall extending transversely from the back wall to form a partial enclosure operable to receive at least one surveillance camera and a second portion including a cylindrical front wall having a substantially cylindrical aperture, the second portion being operable for removable connection to any of the first portions to form the housing such that the substantially cylindrical aperture is operable to permit a field of view for the at least one surveillance camera. In accordance with this aspect of the present invention, each first portion is designed for a different mounting application. In particular, the housing in accordance with this aspect of the present invention may be designed such that one of the plurality of first portions side walls extend to the back wall at an angle such that the back wall width is less than the frontal frame width thereby allowing the housing to be mounted in a horizontal or vertical corner. In addition, by adjusting the width of the side walls the housing may be mounted more flushly against a wall.

In another aspect of the present invention, a surveillance device for observing a surveillance location comprising a housing formed in a shape having a tubular aperture; and a first video camera mounted within the housing interior on a first camera gimbal, the first camera gimbal including at least two perpendicular axes of rotation to allow horizontal and vertical swivel positioning and adjustment of the first video camera, the first video camera having a viewing angle of substantially 180°. In accordance with this aspect of the present invention, the surveillance device includes a wide viewing angle and therefore is able to support a variety of applications including being mounted in the middle of a corridor, in a corner, or be mounted on a cornice. In either of the mounting positions, the camera has a wide angle of view and can provide surveillance over a wide viewing angle of approximately 180°. In addition, where the camera is mounted to a ceiling the viewing angle is increased to substantially 360°.

In yet another aspect of the present invention, the housing includes flanges or frames that slope forward away from the back wall and the rear flanges slope downward towards the back walls such that the rear flange and front flange are mounted flushly to provide a substantially airtight interior. In accordance with this particular aspect of the present invention, the housing provides an airtight, almost hermetically sealed, environment which substantially enhances the reliability of the cameras mounted within the housing.

Further, in accordance with yet another aspect of the present invention, the housing further comprises a first video camera mounted within the housing on a first camera gimbal, the first camera gimbal including at least two perpendicular axes of rotation to allow horizontal and vertical swivel positioning and adjustment of the first video camera so as to allow the first video camera to have a viewing angle of substantially 180°. As a further improvement to this particular aspect of the present invention, an embodiment is provided wherein the first video camera can be panned about the viewing angle.

In yet another embodiment in accordance with the present invention, a second video camera may be mounted within the housing on a second camera gimbal, the second camera gimbal including at least two perpendicular axes of rotation to allow horizontal and vertical swivel positioning and adjustment of said video camera so as to allow said second video camera to have a viewing angle of substantially 180°. With two cameras in the housing, one video camera can be pointing in an opposite direction to the other video camera thereby allowing for full time surveillance in opposite directions.

### BRIEF DESCRIPTION OF THE DRAWINGS

FIG. 1A is a perspective view of an exemplary embodiment of the present invention;

FIG. 1B is a front view of the exemplary embodiment of FIG. 1A;

FIG. 1C is a side view of the exemplary embodiment of FIG. 1A;

FIG. 1D is a top view of the exemplary embodiment of FIG. 1A;

FIG. 2A is a front view of the body of a housing in accordance with an aspect of the present invention;

FIG. 2B is a front view of the hood of a housing detached in accordance with an aspect of the present invention;

FIG. 2C depicts a top view of an alternate embodiment of a housing in accordance with an aspect of the present invention;

FIG. 2D is a cross-sectional view of the body of FIG. 2A taken along the line 2D-2D;

FIG. 2E is a cross-sectional view of the hood of FIG. 2B taken along the line 2E-2E;

FIG. 3A illustrates a rear view of a hood of a housing in accordance with an embodiment illustrative of an aspect of the present invention;

FIG. 3B illustrates a front view of a hood of a housing in accordance with an aspect of the present invention;

FIG. 4A is a perspective view of a second embodiment of a housing in accordance with an aspect of the present invention;

FIG. 4B is a side view of the embodiment of FIG. 4A;

FIG. 4C is a top view of the embodiment of FIG. 4A;

FIG. 5A is a perspective view of a third embodiment of a housing in accordance with an aspect of the present invention;

FIG. 5B is a side view of the housing of FIG. 5A; and

FIG. 5C is a top view of the housing of FIG. 5A.

### DETAILED DESCRIPTION

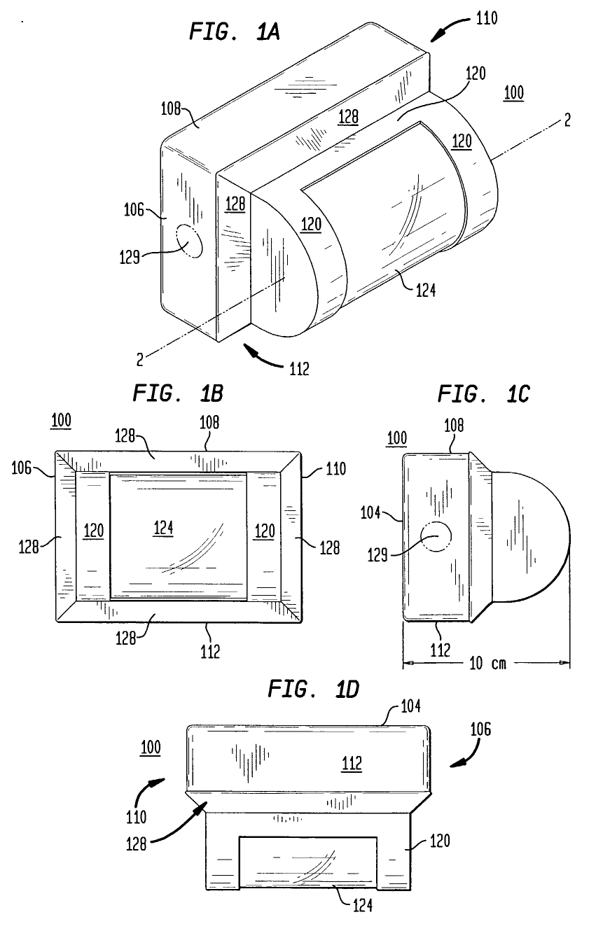

Referring to FIGS. 1A, 1B, 1C and 1D, there are shown different views of a housing 100 for a surveillance device in accordance with one or more aspects of the present invention. As FIG. 1 shows, the housing 100 comprises a back wall 104 and four side walls 106, 108, 110, and 112. Opposite back wall 104 is an upper cylindrical side wall 120 having an opening 124 and a rear flange member 128. In accordance with an aspect of the present invention, the back wall 104 and four side walls 106, 108, 110, and 112 preferably constitute a first (rear) portion of the housing 100. Further, in accordance with this aspect, the cylindrical side wall 120 and rear flange member 128 preferably constitute a second (front) portion of the housing 100 with the opening 124 centered in cylindrical wall 124 as shown in FIGS. 1A and 1D. The housing 100 is preferably formed by mounting or fastening the first and second portions together.

There are other alternatives to forming the apparatus 100, including a structure where the side walls 106, 108, 110, 112 and the upper cylindrical side wall 120 form one portion of the housing. In this latter embodiment, the back wall 104 is detachably mounted to the four side walls 106, 108, 110, 112 to form the enclosed housing 100.

As best seen in FIGS. 1A, 1B and 1D, the opening 124 is preferably formed in a cylindrical shape into which an opaque glass may be mounted. As FIGS. 1A and 1D show, the opening 124 comprises a cylindrical shape and occupies most of the surface area of cylindrical side wall 120. In this way, the opening 124 provides a side-to-side viewing angle about axis 2-2 of approximately 180°. In practice, the opening 124 is sealed with a sturdy and opaque glass. Further, on at least one side wall, such as side wall 106, an opening 129 is provided through which cabling, necessary for operating the camera, may be inserted or threaded. Such cabling may include cabling for transmitting a video signal and for powering one or more cameras within the housing.

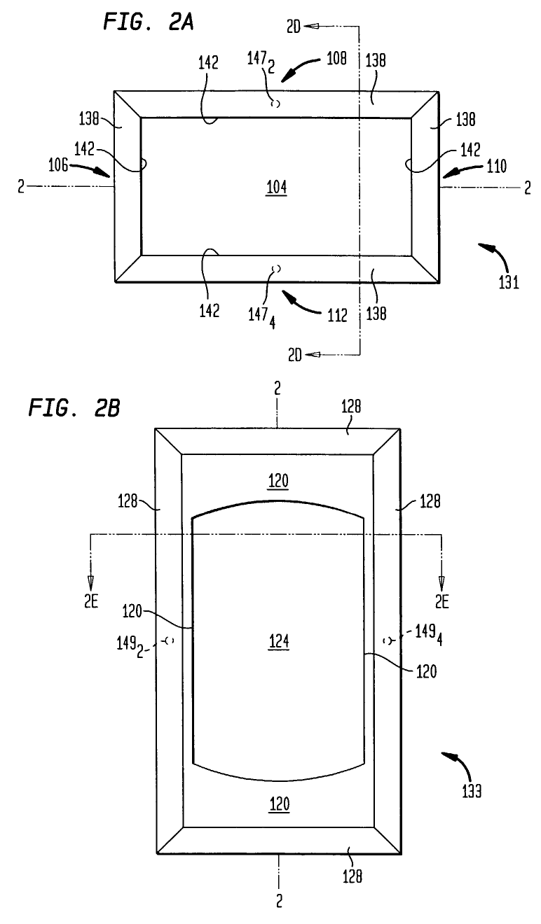

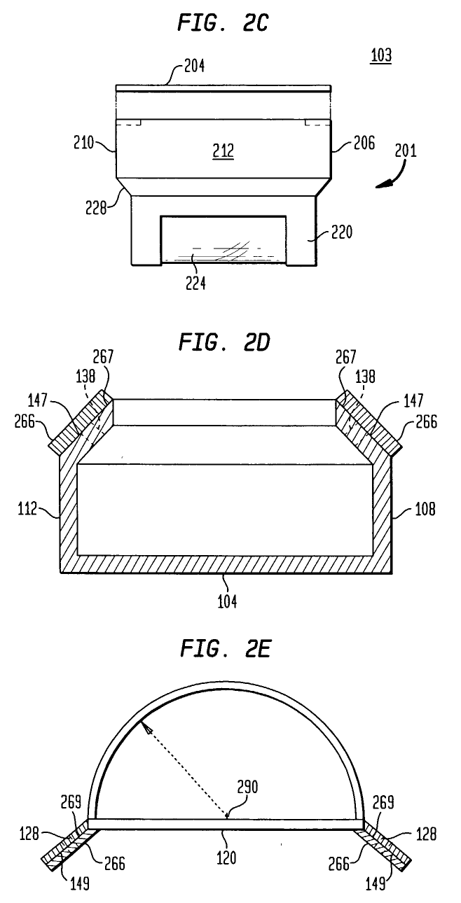

FIGS. 2A and 2B illustrate the first portion or body 131 and the second portion or hood 133, respectively. The body 131 and the hood 133 are secured or fastened together to form the housing 100. As FIG. 2A shows, the body 131 may be comprised of a single piece or structure formed by side walls 106, 108, 110, and 112, bottom wall 104, and a frontal flange 138. The frontal flange 138 terminates at edges 142 thereby defining a frontal opening above bottom wall 104. In addition, the frontal flange 138 serves as the mounting surface for rear flange 128. The body 131 therefore forms an open box structure.

As FIG. 2B shows, the hood 133 is comprised of rear flange member 128 and upper cylindrical side wall 120. The upper cylindrical side wall 120 terminates at edges 152 to define the cylindrical opening 124. As previously discussed, the cylindrical opening 124 is preferably sealed or closed with an opaque glass thereby allowing for surveillance while protecting the cameras installed within the housing 100. The cylindrical opening 124 advantageously provides a wide angle of view about the longitudinal axis 2-2 of approximately 180°. As is discussed in further detail below, in most applications the housing 100 is mounted with longitudinal axis 2-2, which extends in a direction along the length of the housing 100, being perpendicular to the intended field of view. For example, if the application requires installation along a corridor to monitor the area extending in opposite directions down the corridor, then the housing 100 is preferably mounted with the longitudinal axis 2-2 being substantially perpendicular to the ceiling or floor.

As also shown in FIGS. 2A and 2B, the body 131 includes apertures 147 and the hood 133 includes apertures 149, which are used to secure body 131 to the hood 133 when forming housing 100. Although FIGS. 2A and 2B show that each of the body 131 and the hood 133 preferably have two fastening apertures, i.e., 147₂ and 147₄ and 149₂ and 149₄, respectively, four fastening apertures may also be used for securing the body to the hood. Nevertheless, we have found that apertures 147₂, 147₄, 149₂ and 149₄ are adequate for securing the body 131 to the hood 133.

In accordance with one or more further aspects of the invention, as best seen in FIG. 2D, front flange 138 of the body 131 is preferably sloped at an angle upwardly from the side walls 106, 108, 110, 112 to edges 142, forming an angle flange. Sloping up to approximately 45° is usually adequate. The rear flange 128, as best seen in FIG. 2E, is preferably sloped downwardly at approximately the same angle from the upper cylindrical side wall 120, forming a mating flange. When the body 131 and the hood 133 are secured at their respective flanges 138, 128 the housing is substantially airtight. Of course, the flanges 138, 128 of the housing may be made without an angled flange; however, such an implementation may not protect the cameras as well as the sloped flange.

Those of ordinary skill in the art will note that the housing 100 may be made using other structures than the hood and body arrangement of the embodiment described hereinabove. For example, an alternate embodiment may include the four side walls 106, 108, 110, and 112 mated with the cylindrical side wall 120, such as by forming a single piece or structure. In such an alternate embodiment, the back wall 104 is preferably detachably mounted to the sidewalls 106, 108, 110, 112, 120, thereby allowing access to the interior of the housing. It is noted that in this embodiment, front flange 138 would not be needed. Instead, such a flange may be placed at the end of this alternate structure where the back wall 104 is secured. FIG. 2C depicts this alternate embodiment of the invention by showing a housing 103. In particular, a first portion 201 comprises side walls 206, 210 and 212. A fourth side wall is not shown but is understood to be opposite side wall 212. The first portion 201 additionally includes upper flange 228, cylindrical side walls 220 and opening 224 (depicted as sealed with an opaque glass). The back wall 204 completes the housing 103 when it is secured to first portion 201. Those of ordinary skill in the art will recognize from this disclosure that alternative configurations of the housing are possible without departing from the scope of the present invention, it being preferred, however, that such configurations include the cylindrical view aperture or port.

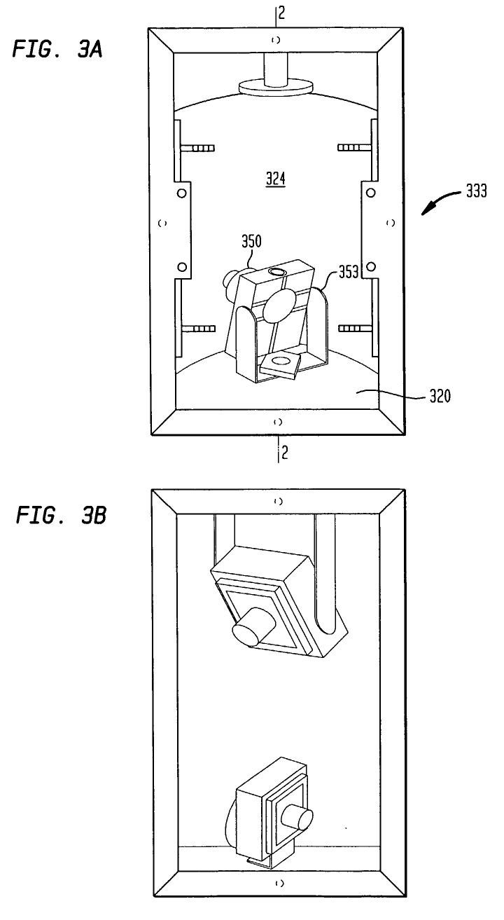

Returning to FIG. 2E, there is shown a window radial center 290 within the surveillance housing in accordance with aspect of the present invention. Because the radial center 290 is within the housing, the viewing angle allowed of a camera is considerably wider than available in the prior art. In accordance with an embodiment of the present invention, the window radial center 290 may be chosen so as to coincide with the focal point of the camera within the housing (e.g., see FIG. 3B). In this way, the housing will accommodate the rotational limit of even large cameras and provide substantially 180° field of view. In addition, a smaller camera can be positioned in front of the radial center point (e.g., see FIG. 3A) so as to further increase the field of view. In this way, housings implemented in accordance with this aspect of the invention advantageously allow for a large viewing angle while at the same time allowing the flexibility for many different types of cameras to be installed in such housings.

Referring to FIG. 3A, there is shown a rear view of hood 333 of a housing in accordance with an embodiment illustrative of an aspect of the present invention. As FIG. 3A shows, a camera 350 is installed on a camera gimbal 353. The camera gimbal 353 is mounted onto cylindrical side wall 320. This particular mounting arrangement allows the camera 350 to be rotated about longitudinal axis 2-2. The cylindrical aperture 324 allows the camera, via adjustment of the gimbal, a viewing angle of substantially 180° about longitudinal axis 2-2. FIG. 3B shows a front view of a housing having two cameras in accordance with an alternate embodiment of the present invention. In the embodiment of FIG. 3B, two cameras are mounted on the respective gimbals within the interior. Each camera can be positioned to the opposite direction simultaneously and therefore can be advantageously placed in the center of a corridor.

Referring again to FIG. 3A, those of ordinary skill in the art will note that camera 350 may be mounted on a support that allows the camera to be rotated or panned about along the longitudinal axis 2-2. Such an arrangement may be advantageous where the location is not usually crowded or where a second camera proves too costly.

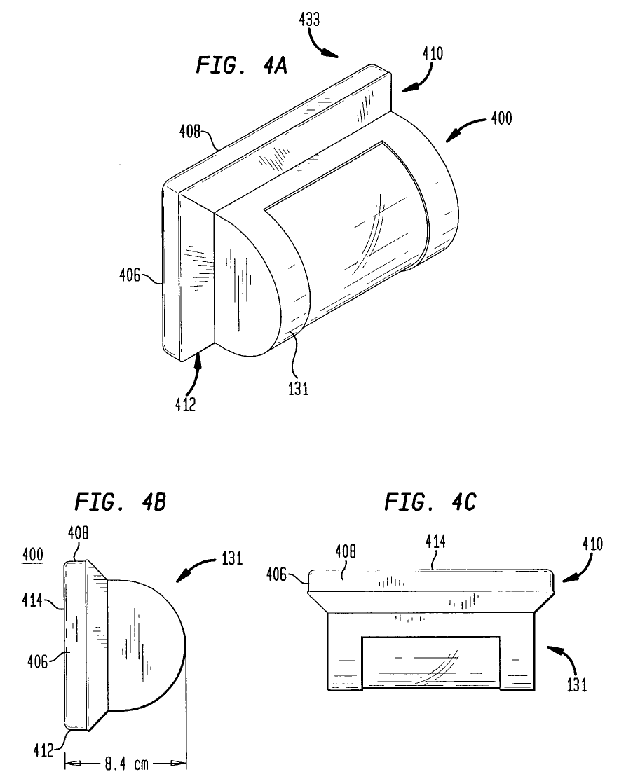

As previously discussed, the housing may be formed by securing a hood 133 to a body 131. Such an arrangement advantageously allows the body of the housing to be detachably mounted. As such, different bodies can be mounted to the same hood. In particular, and by way of reference to FIG. 4, a body 433 comprising shorter side walls 406, 408, 410, and 412 and a back wall 414 may be secured to hood 131 to form a housing 400. In this embodiment, the height of the housing 400 is approximately 84 millimeters. In comparison, the height of the housing 100 is approximately 100 millimeters. The housing 400 advantageously allows the surveillance device to be mounted more flushly than in the case of housing 100. Such an embodiment may be particularly useful where the camera is desired to be mounted along a cornice.

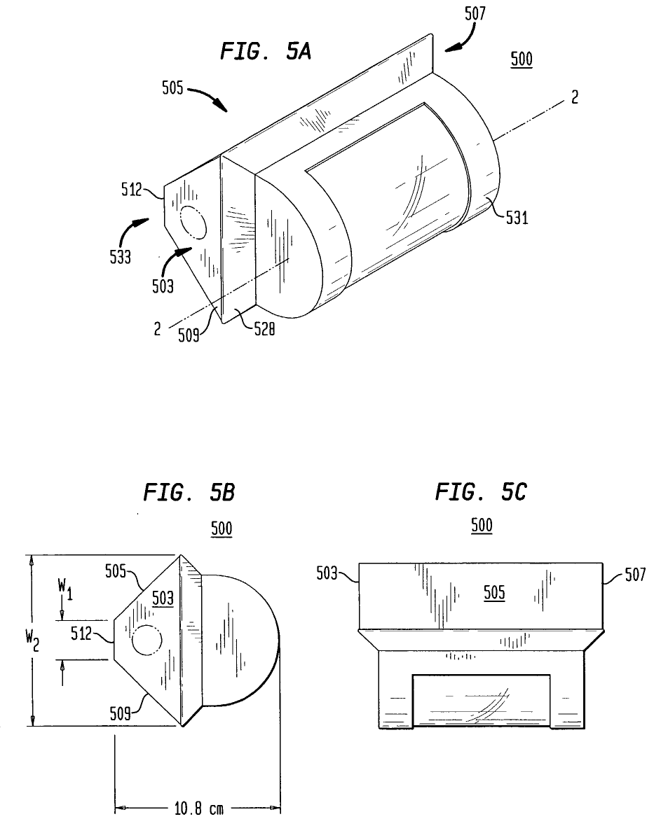

Turning now to FIG. 5, there is depicted a housing 500 in accordance with another aspect of the present invention. In particular, the body 533 of housing 500 comprises side walls 503, 505, 507, and 509 and also includes back wall 512. The side walls 505 and 509 are angled towards the back wall 512 such that the width, W₁, of housing 500 as measured along the back wall 509 is smaller than the width, W₂, as measured where the rear flange 528 of the hood 531 is secured to the body 533. In accordance with this embodiment, the housing 500 may easily be mounted in a corner so that two surveillance cameras can be positioned to monitor the two corridors intersecting at the corner. In such an application, the housing 500 is wedged into the corner with the longitudinal axis 2-2 of the housing 500 being perpendicular to the floor. In another application, the housing 500 may be mounted in the corner formed by the intersection of a wall and a ceiling. In such an application, the housing is mounted with longitudinal axis 2-2 being oriented parallel to the floor. Further, as illustrated in FIG. 5B, the height of housing 500 is approximately 108 millimeters as measured from the back wall 512 to the cylindrical upper wall 531.

As discussed hereinabove, where the housing comprises a base and hood that are secured together the base may be detachably mounted and interchanged among the bases depicted in FIGS. 1, 4, and 5. Those of ordinary skill in the art will note that by separating the housing into a base and hood, bases may be made to match almost any application without sacrificing any of the other advantages of the housing. In particular, the wide field angle view afforded by the cylindrical aperture is still available for all such applications. In addition, the flanges of the body and hood may still be sloped to provide better securing of the hood to body.

Where the housing is formed by securing a hood to a body, several fastening means are available. We have found that with the flanges of both the body and the hood sloped, two screws may be used to secure that arrangement yet while providing a good enough seal to allow for reliable and safe operation of the camera within the housing. Alternatively, four screws may also be used to secure such an arrangement. Of course, any means of fastening which allows the hood and body to be detachably mounted yet while providing adequate sealing may be used.

In addition, the sealing of the housing may be improved by application of an adhesive strip on the surface of the flange 138 or the bottom surface of flange 128. In particular and with reference to FIGS. 2D and 2E, an adhesive strip 266 may be applied to the upper surface 267 of the flange member 138 to provide an almost hermetic seal when the hood and body are secured together. Alternatively, the strip 266 may be applied to the bottom surface 269 of flange member 128. Further, in accordance with an alternative embodiment of the present invention, where an adhesive strip is able to provide adequate sealing, the use of fasteners may be avoided.

In addition to the other advantages previously discussed, housings implemented in accordance with the present invention advantageously allow installation of larger number and types of cameras then previously allowed by prior art housings. For example, the housing may house a high resolution, auto-iris, vari-focal, color camera for specific target viewing in a bright daylight environmental (e.g., supermarket parking lot entry), and at the same time, a wide-angle, monochrome camera suitable for general surveillance in lowlight conditions, e.g., after hours, winter conditions.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A housing, comprising:
a back wall;
at least one side wall extending transversely from the back wall to form a partial enclosure operable to house at least one surveillance camera; and
a cylindrical front wall having a substantially cylindrical aperture, said cylindrical front wall being coupled to said partial enclosure to form the housing such that said substantially cylindrical aperture is operable to permit a field of view for allowing camera surveillance about a focal point of a camera, said cylindrical aperture having a radial center of view in the housing.

2. The housing of claim 1, wherein:
said partial enclosure includes a peripheral flange at an edge of at least one side wall such that said flange is spaced away from said back wall; and
said cylindrical front wall having a peripheral flange at an edge of the cylindrical wall, and
said peripheral flanges being sized and shaped to mate with one another to substantially seal the housing.

3. The housing of claim 2 wherein said peripheral flange of said partial enclosure slopes forward away from said back wall and said peripheral flange of said cylindrical side wall slopes downward towards said back wall such that said peripheral flange of said partial enclosure and said peripheral flange of said cylindrical side wall can be mated to provide a substantially air tight interior.

4. The housing of claim 1 further comprising a first video camera mounted within the housing on a first camera gimbal, said first camera gimbal including at least two perpendicular axes of rotation to allow horizontal and vertical swivel positioning and adjustment of said video camera so as to allow said first video camera to have a viewing angle of substantially 180 degrees.

5. The housing of claim 4 wherein said first video camera is panned about said viewing angle.

6. The housing of claim 4 further comprising a second video camera mounted within the housing on a second camera gimbal, said second camera gimbal including at least two perpendicular axes of rotation to allow horizontal and vertical swivel positioning and adjustment of said video camera so as to allow said second video camera to have a viewing angle of substantially 180 degrees.

7. The housing of claim 1 further comprising first and second video cameras each mounted on respective first and second camera gimbals, each of said camera gimbals including at least two perpendicular axes of rotation to allow horizontal and vertical swivel positioning and adjustment of said video camera so as to allow said first video camera to have a viewing angle of substantially 90 degrees.

8. The housing of claim 1 wherein said at least one side wall extends to said back wall at an angle such that said back wall width is less than the housing width at said peripheral flange of said partial enclosure.

9. The housing of claim 8 wherein said housing has a height of approximately 10.8 centimeters.

10. The housing of claim 1 wherein said housing has a height of approximately 10 centimeters.

11. The housing of claim 1 wherein said housing has a height of approximately 8.4 centimeters.

12. The housing of claim 16 wherein said cylindrical aperture further comprises an opaque glass having a substantially cylindrical shape mounted through an opening in said cylindrical front wall.

13. A housing kit, comprising:
at least one first portion, each of said least one first portion including a back wall and at least one side wall extending transversely from the back wall to form a partial enclosure operable to receive at least one surveillance camera; and
a second portion including a cylindrical front wall having a substantially cylindrical aperture, said second portion being operable for removable connection to any of said at least first portions to form the housing such that the substantially cylindrical aperture is operable to permit a field of view for the at least one surveillance camera.

14. The housing kit of claim 13, wherein some of said at least one first portion are sized and shaped differently from one another such that different sized and shaped housings may be obtained.

15. The housing kit of claim 13, wherein:
said partial enclosure includes a peripheral flange at an edge of at least one side wall such that said flange is spaced away from said back wall; and
said cylindrical front wall having a peripheral flange at an edge of the cylindrical wall, and
said peripheral flanges being sized and shaped to mate with one another to substantially seal the housing.

16. The housing kit of claim 15 wherein said peripheral flange of said partial enclosure slopes forward away from said back wall and said peripheral flange of said cylindrical side wall slopes downward towards said back wall such that said peripheral flange of said partial enclosure and said peripheral flange of said cylindrical side wall can be mounted to provide a substantially air tight interior.

17. The housing kit of claim 13 wherein said at least one side wall extends to said back wall at an angle such that said back wall width is less than the housing width as measured at said peripheral flange of said partial enclosure.

18. The housing kit of claim 13 wherein said at least one first portion is shaped and sized to be wedge mounted.

19. The housing kit of claim 13 wherein said at least one first portion is shaped and sized to be cornice mounted.

20. A surveillance device for observing a surveillance location comprising:
a housing formed in a shape having a tubular aperture; and
a first video camera mounted within said housing interior on a first camera gimbal, said first camera gimbal including at least two perpendicular axes of rotation to allow horizontal and vertical swivel positioning and adjustment of said first video camera, said first video camera being arranged to have a viewing angle of substantially 180 degrees.

21. The housing of claim 20 wherein said first video camera is panned about said viewing angle.

22. The housing of claim 20 further comprising a second video camera mounted within the housing on a second camera gimbal, said second camera gimbal including at least two perpendicular axes of rotation to allow horizontal and vertical swivel positioning and adjustment of said video camera so as to allow said second video camera to have a viewing angle of substantially 180 degrees.

23. The housing of claim 20 further comprising first and second video cameras each mounted on respective first and second camera gimbals, each of said camera gimbals including at least two perpendicular axes of rotation to allow horizontal and vertical swivel positioning and adjustment of said video camera so as to allow said first video camera to have a viewing angle of substantially 90 degrees.

24. The surveillance device of claim 20, wherein said housing further comprises:
a first portion having a back wall and four side walls secured to said back wall to constitute a single open box structure, each of said side walls being terminated at an end opposite said back wall on a frontal flange, said frontal frame having an edge and extending in a direction perpendicular to each of said walls and forming a frontal opening at said frontal flange edge; and
a second portion having a rear flange secured to a front wall formed in said shape having said tubular aperture to constitute a single piece, said tubular aperture allowing for camera surveillance, and
wherein said first portion is mounted to said second portion by securing said front flange to said rear flange to form the housing.

25. The housing of claim 24 wherein said frontal frame slopes forward away from said back wall and said rear frame slopes downward towards said back wall such that said rear flange and front flange are mounted to provide a substantially air tight interior.

26. The housing of claim 24 further comprising an adhesive strip secured to a surface of said frontal flange so that when said frontal flange is mounted to said rear flange the adhesive strip forms a seal.

27. The housing of claim 24 further comprising an adhesive strip secured to a surface of said rear flange so that when said frontal flange is mounted to said rear flange the adhesive strip forms a seal.
